(19) United States
(12) Patent Application Publication
(10) Pub. No.: US 2006/0199719 A1
(43) Pub. Date: Sep. 7, 2006

(54) Roll stand paper guide

(76) Inventors: Thornton Clifford White, Cattaraugus, NY (US); Christopher F. Cadigan, Orchard Park, NY (US)

Correspondence Address: HODGSON RUSS LLP, ONE M & T PLAZA, SUITE 2000, BUFFALO, NY, 14203-2391, US

(21) Appl. No.: 11/070,059

(22) Filed: Mar. 2, 2005

(51) Int. Cl. B31B 1/00

(52) U.S. Cl. 493/464

(57) ABSTRACT

A continuous guide member having a width greater than a height and a method of guiding a web of material in the manufacture of rolled sticks. The method of making sticks includes providing a supply roll having a continuous web of material. The web of material is received onto a presser roll having at least one recess. A cutter roll having at least one knife is rotated in an opposite direction as the presser roll. The cutter roll is located in a spaced apart relation to the presser roll. The web of material is guided with a guide member onto a crimper roll. An indentable roll is rotated in opposite direction as the crimper roll. The indentable roll is disposed in spaced apart relation to the crimper roll. The web of material is cut with the at least one knife on the cutter roll. The web of material is convoluted with the crimper roll.

### FIELD OF THE INVENTION

This invention relates to rolled sticks and similar articles, methods of manufacturing them, and apparatus for effecting such methods. It is concerned with the manufacture of such articles from paper or other web material by rolling strips of such material on themselves to form rigid self-sustaining bodies. In particular, the invention relates to an improved guide which allows for a variety of web materials of various thicknesses moving at various speeds to be processed into rolled sticks.

### BACKGROUND OF THE INVENTION

The prior art has disclosed various machines for making paper sticks, but all have suffered from inefficiencies in output, restricted web material options and unnecessarily increased operational costs. For example, one of the most common web materials used to make sticks is paper. Paper manufacturers have started to migrate away from producing high volumes of lower weight paper webs and move to producing heavier weight paper webs.

The prior art discloses several machines to process webs of paper into rolled sticks. At a particular point in the processing operation, cut lengths of the paper web are guided by thin wire guides into a collection of rollers where convolution of the paper web occurs. The thin wire guides are designed to control a flow of the paper web through the machine. As such, the thin wire guides are ineffective when heavier weight paper is introduced into the machine as they do not have the strength to adequately control the flow of the paper web into the collection of rollers when the machine is run at normal processing speeds.

Paper sticks can be made with less linear length of paper web by using a heavier weight web compared to the required linear length of lighter weight paper. The difference in linear length has proven to cause operational difficulties for the machine. In the prior art, thin wire guides tend to frictionally engage at least one of the rollers creating a pinch point or multiple pinch points. The shorter lengths of heavier weight paper web tend to stack or stick in the pinch points causing the machine to function improperly. Also, the frictional engagement of the thin wire guides against the rollers causes wear and grooving, leading to wrinkles in the paper web.

As such, an object of the present invention is to provide an improvement over the prior art by replacing the thin wire guides with a guide member having a planar portion capable of guiding a heavier weight paper web moving at high speed. It will be apparent to one of ordinary skill in the art that utilizing a heavier weight paper affords many advantages above the lower weight paper, including lower acquisition costs from the paper manufacturers, the ability to utilize shorter lengths of the cut paper when rolling to make sticks of equal diameter as those made from the lower weight paper, and the ability to run the machine at a high speed, thus, when taken in combination with the shorter lengths of cut paper, yielding an increase in productivity. Additional benefits of the invention may include reduced machine down time, reduced wear and tear on machine components and less wrinkled products.

### SUMMARY OF THE INVENTION

The apparatus illustrated in the accompanying drawings receives a web of material unwound from a supply roll at a substantially constant speed; cuts the web of paper into strips; subjects the strips to a multiple crimping action along closely spaced parallel lines to initiate their convolution; continues the convoluting action to form loose rolls and compacts and bonds the loosely convoluted rolls into substantially solid and self-sustaining rod-like bodies.

The present invention may be embodied as a paper guide capable of guiding a web of material in the manufacture of rolled sticks. The invention includes a method of making sticks by providing a supply roll having a continuous web of material and receiving the web of material onto a presser roll having at least one recess. A cutter roll having at least one knife may be rotated in an opposite direction as the presser roll, the cutter roll being located in a spaced apart relation to the presser roll. The web of material may be guided by a guide member to where it may be received onto a crimper roll. An indentable roll may be rotated in an opposite direction as the crimper roll, the indentable roll being disposed in spaced apart relation to the crimper roll. The web of material may be cut with the knife on the cutter roll, and convolution of the web of material may be caused by the crimper roll.

The machine in which the paper guide may be utilized may include a supply roll having a continuous web of material. The invention may include a presser roll rotating in a first direction having a recess and capable of receiving the web of material and a cutter roll having a knife disposed in adjacent relation to and rotating in a second direction opposite the direction of the presser roll. A guide member is capable of guiding the web of material onto a crimper roll capable of convoluting the web of material. An indentable roll may also be included and disposed in operative relation to an oppositely rotating crimper roll, thus forming a nip.

### BRIEF DESCRIPTION OF THE DRAWINGS

For a fuller understanding of the nature and objects of the invention, reference should be made to the accompanying drawings and the subsequent description. Briefly, the drawings are:

FIG. 1 is a side elevational schematic view of a stick making machine;

FIG. 2 is a side elevational schematic view of a roll stand guide depicting a paper guide in operable relation to adjacent elements;

FIG. 3 is a front elevational view of the paper guide;

FIG. 4 is a side elevational view of the paper guide;

FIG. 5 is a side elevational view of an angle block; and

FIG. 6 is a front elevational view of an angle block.

### FURTHER DESCRIPTION OF THE INVENTION

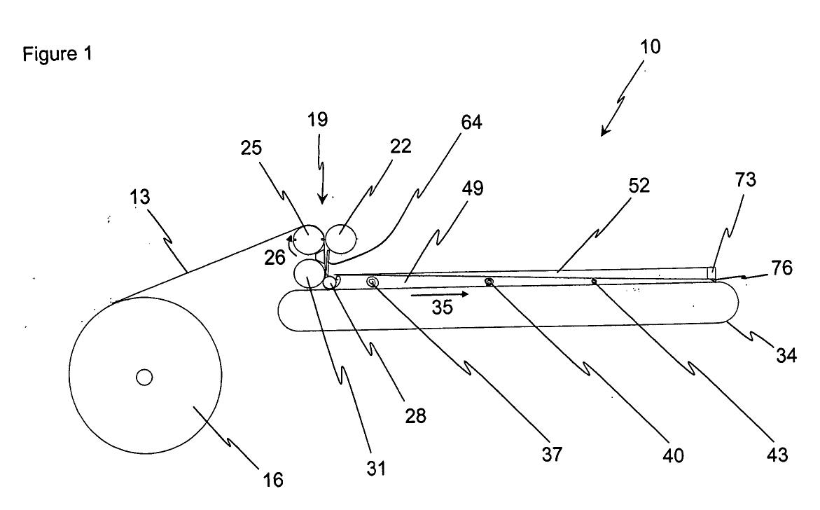

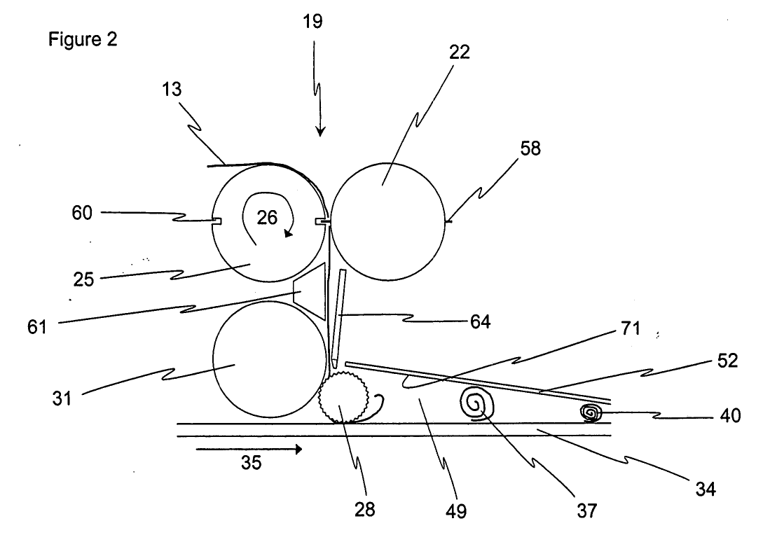

Referring to FIGS. 1 and 2, and generally to the operation of a machine 10, paper 13 may run continuously through the machine 10 from a rotatable supply roll 16. The paper 13 may first move to a roll stand 19 where it may pass between a cutter roll 22 and a co-acting recessed roll 25. The cutter roll 22 may have diametrically opposed knives 58 which may enter similarly positioned recesses 60 in the recessed roll 25 as the rolls 22, 25 rotate. The paper 13 may be cut into desired lengths.

Cut lengths of paper may then be advanced to a position wherein they may be forced against a crimper roll 28 by a rubber faced roll 31. As the rubber faced roll 31 is driven, each cut length of paper may be crimped and advanced partially about an arc of the crimper roll 28. As the crimped portion approaches an end of this arc, it may be separated from the crimper roll 28 and may begin to form convolutions, the number of which may be increased by the subsequent advance of the cut length of paper. This formation of convolutions may then continue by the action of the endless belt 34 which may be continuously driven so that its upper run moves in the direction of arrow 35 as shown in FIGS. 1 and 2. Formation of loosely convoluted rolls 37, 40, 43 may take place in different stages. The endless belt 34 may cause the convoluted rolls 37, 40, 43 to advance through a roll compacting passageway 49. An upper surface of the endless belt 34 forms a lower side of the roll compacting passageway 49 and an upper side of the roll compacting passageway 49 may be formed by a gripping surface 71 of a presser plate structure 52. The presser plate structure 52 is angled with respect to the endless belt 34 such that the distance between the two gradually decreases in the direction of the belt travel to properly perfect the shape of the ultimate product.

By reason of the rotation of the recessed roll 25 in the direction of arrow 26 (see FIGS. 1 and 2), the paper 13 may be maintained under tension between the supply roll 16 and the roll stand 19.

The cutter roll 22 may be a cylinder having a shaft journalled in anti-friction bearings in the roll stand 19 sides. The knives 58 of the cutter roll 22 may be saw tooth blades and may be positioned in slots in an outer surface of the cutter roll 22 along lines which may be parallel to a longitudinal axis of the cutter roll 22. Teeth of the knives 58 cut through the paper 13 with a minimum of resistance. The knives 58 may be held rigidly in their operative positions.

The cutter roll 22 and the recessed roll 25 may be driven at the same speed and in opposite directions. Because of the necessity for quick and clean cutting action on the part of the cutter knives 58, the machine 10 may be arranged so the knives 58 contact the paper 13 stretched across one of the recesses 60 in the recessed roll 25. It is essential a proper angular relationship of the rolls 22, 25 be maintained so the knives 58 may not contact the surface of the recessed roll 25 beyond the confines of the recesses 60.

Beyond a position at which the paper 13 is cut into lengths, the paper 13 may extend through an upright passage which may be defined on one side by a fixed member 61 and on a second side by a paper guide 64. The fixed member 61 and paper guide 64 may be held between the recessed roll 25 and the rubber faced roll 31. The fixed member 61 may have its upper and lower surfaces shaped to correspond with the surfaces of the recessed roll 25 and the rubber faced roll 31 in order that it may fit closely and provide as small of an opening as possible through which the paper might accidentally pass. In this passageway, a leading edge of the cut length of paper is guided to a position where the crimper roll 28 and the rubber faced roll 31 meet and form a nip. When these two elements grip the cut length of paper, they cause the paper 13 to advance while the paper is under tension across the recesses 60 of the recessed roll 25 before the next cutting operation occurs.

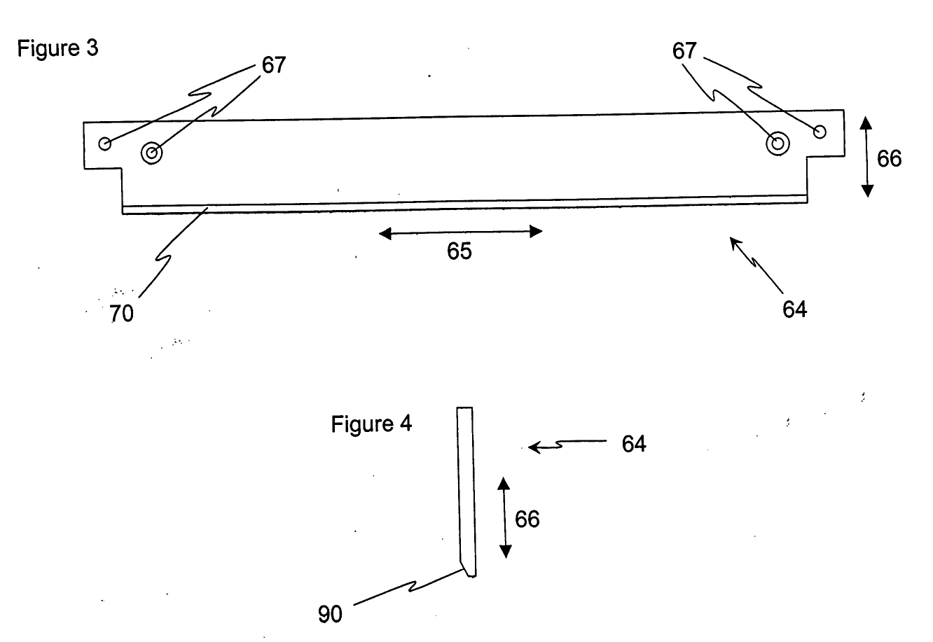

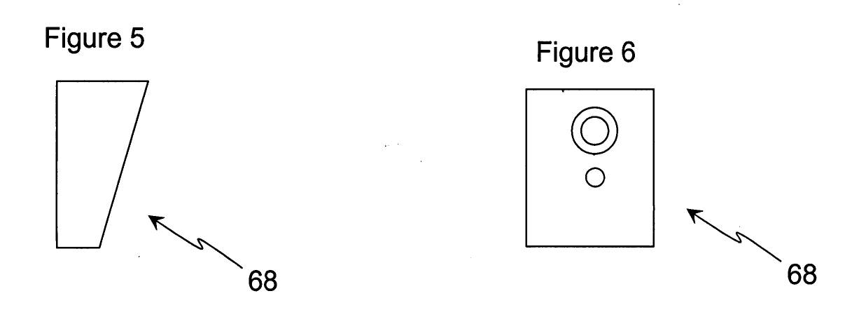

As is shown in FIGS. 3 and 4, the paper guide 64 may be a continuous plate-like structure (or structures) having a width 65 greater than its height 66. It may be fastened to the sides of the roll stand 19 and may have a plurality of holes 67 to assist in fastening to the machine 10. The paper guide may be mounted at an angle using angle blocks 68 (shown in FIGS. 5 and 6) which would allow paper to be received at a variety of angles into a proper position such that the crimper roll 28 would be able to grip the cut strip.

The paper guide 64 may be designed to guide paper 13 of various thicknesses which may move at various speeds through the machine 10 and may have at least one beveled edge 70 to assist in guiding the paper 13. The paper guide 64 may be made of metal or, as in the preferred embodiment, may be made of plastic, such as a polycarbonate resin and be transparent to allow monitoring of the machine operation without disassembly.

In alternative embodiments, the paper guide 64 may be grooved, have ridges or be otherwise shaped to provide reduced friction between the paper 13 and the paper guide 64.

In another embodiment, the paper guide 64 may be shaped like a bar extending across a width of the roll stand 19. The bar may have substantially planar plate-like portions wherein these plate-like portions may be substantially flat or may be formed so as to reduce friction between the paper 13 and the paper guide 64 as described above.

Referring now to FIG. 2, the leading edge of each strip may be guided to a position at which the crimper roll 28 and the rubber faced roll 31 form a nip. The crimper roll 28 is driven by the rubber faced roll 31, and the ribs of the crimper roll 28 are indented into the rubber roll 31. When these elements grip the severed strip of paper in the nip, they cause the strip to advance before the next strip cutting operation occurs such that the paper is under tension across the recesses 60 of the recessed roll 25. Thus, the paper 13 in passing from the point at which it is cut by one of the knives 58 and is sharply crimped along parallel lines, and may be simultaneously gripped such that it may advance. As the operation of the machine 10 continues, the leading edge of the cut paper proceeds around the crimper roll 28 until it is removed from the crimper roll 28. As the crimper roll 28 continues to rotate, the leading edge of the released stick strip contacts with the gripping surface 71 which may be located on the lower surface of the presser plate structure 52.

Further, continued-action of the parts and the effect of the crimping on the leading edge of the cut paper causes initial convolutions to begin to form. The endless belt 34, by reason of its effect upon a lower part of the released paper strip, promotes further convoluting action until a first convolution may be completed. Thereafter, the loosely convoluted paper roll is released from the crimper roll 28 and its number of convolutions may be increased by reason of the gripping surface 71 of the roll compacting passageway 49 and the relative movement of the endless belt 34. Action continues in this manner, increasing the number of convolutions of the rolls 37, 40, 43 and decreasing the size thereof, as the rolls 37, 40, 43 proceed through the roll compacting passageway 49 between the endless belt 34 and the gripping surface 71 of the roll compacting passageway 49 (as shown in FIGS. 1 and 2). This roll compacting passageway 49 is tapered so that it decreases in size away from the crimper roll 28.

Blocks 73 may have a plurality of frictionally held knives 76. Leading edges of these knives 76 may be even with a lower surface of the blocks 73, and rear ends of the knives 76 may extend into the roll compacting passageway 49 to about half the diameter of the convoluted rolls. As the rolls 37, 40, 43 travel down the roll compacting passageway 49, they encounter the knives 76 extending into the roll compacting passageway 49. The movement of the endless belt 34 causes the rolls 37, 40, 43 to be cut into desired lengths and have their ends trimmed.

While the invention has been described in connection with certain preferred embodiments, it is not intended to limit the scope of the invention to the particular forms set forth, but, on the contrary, it is intended to cover such alternatives, modifications, and equivalents as may be included within the spirit and scope of the invention as defined by the appended claims.

What is claimed is:

1. An apparatus comprising:
a) a supply roll having a continuous web of material;
b) a presser roll rotating in a first direction having at least one recess, the presser roll capable of receiving the web of material;
c) a cutter roll having at least one knife, the cutter roll disposed adjacent to and rotating in a second direction opposite the direction of the presser roll;
d) a continuous guide member having a width greater than a height and capable of guiding the web of material;
e) a crimper roll capable of receiving the web of material from the guide member, the crimper roll capable of convoluting the web of material; and
f) an indentable roll disposed in operative relation to the crimper roll and rotating in an opposite direction as the crimper roll such that a nip is formed between the crimper roll and the indentable roll.

2. The apparatus of claim 1 wherein the guide member has at least one beveled edge.

3. The apparatus of claim 1 wherein the guide member has at least one mounting location.

4. The apparatus of claim 1 wherein the guide member is capable of guiding webs of material of various thicknesses.

5. The apparatus of claim 1 wherein the guide member is capable of guiding webs of material moving at various speeds.

6. An apparatus comprising:
a) a continuous guide member having a width greater than a height and capable of guiding a web of material;
b) a crimper roll capable of receiving the web of material from the guide member, the crimper roll capable of convoluting the web of material; and
c) an indentable roll disposed in operative relation to the crimper roll and rotating in an opposite direction as the crimper roll forming a nip.

7. The apparatus of claim 6 wherein the guide member has at least one beveled edge.

8. The apparatus of claim 6 wherein the guide member has at least one mounting location.

9. The apparatus of claim 6 wherein the guide member is capable of guiding webs of material of various thicknesses.

10. The apparatus of claim 6 wherein the guide member is capable of guiding webs of material moving at various speeds.

11. A method of making sticks, comprising:
a) providing a supply roll having a continuous web of material;
b) receiving the web of material onto a presser roll having at least one recess;
c) rotating a cutter roll having at least one knife, in an opposite direction as the presser roll, the cutter roll located in a spaced apart relation to the presser roll;
d) guiding the web of material with a continuous guide member having a width greater than a height;
e) receiving the web of material from the guide member onto a crimper roll;
f) rotating an indentable roll in opposite direction as the crimper roll, the indentable roll disposed in spaced apart relation to the crimper roll;
g) cutting the web of material with the at least one knife on the cutter roll; and
h) convoluting the web of material with the crimper roll.

12. The method of claim 1I wherein the guide member has at least one beveled edge.

13. The method of claim 11 wherein the guide member has at least one mounting location.

14. The method of claim 11 wherein the guide member is capable of guiding webs of material of various thicknesses.

15. The method of claim 11 wherein the guide member is capable of guiding webs of material moving at various speeds.
